(19) United States
(12) Patent Application Publication
(10) Pub. No.: US 2023/0159362 A1
(43) Pub. Date: May 25, 2023

(54) FLOATING-ISLAND TYPE ARTIFICIAL WETLAND TREATMENT SYSTEM BASED ON LAKE CENTER PLATFORM

(71) Applicant: Jiangxi Academy of Eco-Environmental Research and Planning, Nanchang City (CN)

(72) Inventors: Meng ZHANG, Nanchang City (CN); Min ZHOU, Nanchang City (CN); Junwei WU, Nanchang City (CN); Mingshu LI, Nanchang City (CN); Bing FENG, Nanchang City (CN); Binghao WAN, Nanchang City (CN); Zugen LIU, Nanchang City (CN)

(73) Assignee: Jiangxi Academy of Eco-Environmental Research and Planning, Nanchang City (CN)

(21) Appl. No.: 17/712,404

(22) Filed: Apr. 4, 2022

(30) Foreign Application Priority Data
Nov. 23, 2021 (CN) 202111393887.1

(51) Int. Cl. C02F 3/32; C02F 1/00; C02F 1/28

(52) U.S. Cl. CPC C02F 3/327; C02F 1/006; C02F 1/281; C02F 1/283; C02F 2103/007

(57) ABSTRACT

A floating-island type artificial wetland treatment system based on a lake center platform is provided. The system includes a lake center platform, a water inflow sub-system including water inflow filled columns, a water drainage sub-system including water drainage filled columns, a water collection and distribution sub-system including water collection tanks, and a platform wetland sub-system; the water drainage filled column is located in a center of a bottom of the lake center platform; the plurality of water inflow filled columns are uniformly distributed at edges of the bottom of the lake center platform with the water drainage filled column as a center; the platform wetland sub-system is located in a center region of an upper surface of the lake center platform; and the plurality of water collection tanks are uniformly distributed at edges of the upper surface of the lake center platform with the platform wetland sub-system as a center.

### TECHNICAL FIELD

The present disclosure relates to the field of ecological interception of eutrophic water pollutants, water quality improvement, and decentralized wastewater treatment, in particular, to a floating-island type artificial wetland treatment system based on a lake center platform.

### BACKGROUND ART

In reality, it is necessary to carry out eutrophication management and lake ecological restoration on a large number of shallow lakes. Therefore, it is of great significance for carrying out ecological restoration on shallow lakes and related treatment on water bloom, and ecological service functions caused therefrom and regained service values are more important.

Current technologies for ecological restoration of rivers and lakes mainly include submerged vegetation restoration, plant community mosaic, artificial wetland treatment, artificial floating islands, sediment dredging, water bloom prevention and control and water purification, blue-green algae collection and concentration, fish community structure regulation, and other technologies. The artificial wetland treatment technology, as a mature technology for sewage treatment, is widely applied to onshore sewage treatment and is partially used for water purification of river branches. Due to the low construction and operation cost and easy maintenance of a project to which the artificial wetland treatment technology is applied, the artificial wetland treatment technology has received wide attention and comprehensive promotion. Under the background of increasing demands for eutrophic water treatment, the artificial wetland treatment technology has a broad application space in in-situ treatment of rivers and lakes. However, river and lake systems impede the development of an artificial wetland technology for river and lake treatment due to restrictions caused by large water level fluctuation, sensitive environment, increasing requirements for the water quality, surrounding available lands, and other factors.

### SUMMARY

The present disclosure aims to provide a floating-island type artificial wetland treatment system based on a lake center platform to overcome the defects and disadvantages of existing in-situ water eutrophication treatment technology, so as to achieve the purpose of in-situ water deeutrophication on the basis of not occupying lands beside a water domain to be purified.

To achieve the above-mentioned purpose, the present disclosure provides the following solution:
A floating-island type artificial wetland treatment system based on a lake center platform comprising: a lake center platform for water purification, a water inflow sub-system, a water drainage sub-system, a water collection and distribution sub-system, and a platform wetland sub-system; the water inflow sub-system includes a plurality of water inflow filled columns and a water collection part provided on each water inflow filled column; the water drainage sub-system includes one or more water drainage filled columns and a water drainage part provided on each water drainage filled column; the water inflow filled columns and the water drainage filled column are filled with multiple kinds of fillers; the water collection and distribution sub-system includes a plurality of water collection tanks and water distribution pipes arranged between the respective water collection tanks; the platform wetland sub-system is filled with multiple kinds of fillers;
the water inflow filled columns and the water drainage filled column are mounted at a bottom of the lake center platform for water purification; the water collection and distribution sub-system and the platform wetland sub-system are mounted on the lake center platform for water purification; wherein, the water drainage filled column is located in a center of the lake center platform for water purification; the plurality of water inflow filled columns are uniformly distributed at edges of the lake center platform for water purification with the water drainage filled column as a center; the platform wetland sub-system is located in a center region of the lake center platform for water purification; the plurality of water collection tanks are uniformly distributed at the edges of the lake center platform for water purification with the platform wetland sub-system as a center; and the water distribution pipes are provided on the platform wetland sub-system.

During operation, the lake center platform for water purification is located in a water domain to be purified; sewage to be purified in the water domain to be purified is introduced into the water inflow filled columns through the water collection parts, and is subjected to primary filtration treatment by the water inflow filled columns; water obtained after the primary filtration treatment is introduced into the water collection tanks and is then introduced, through the water distribution pipes between the respective water collection tanks, to the platform wetland sub-system for secondary filtration treatment by the platform wetland sub-system; water obtained after the secondary filtration treatment flows into the water drainage filled column for third filtration treatment by the water drainage filled column; and the water obtained after the third filtration treatment is drained through the water drainage part.

Alternatively, each of the water collection parts includes a porous water inflow storehouse and a water collection pump; the water inflow filled columns include a fourth filler layer, a third filler layer, a second filler layer, and a first filler layer in sequence from bottom to top; the porous water inflow storehouse is mounted at a bottom of the fourth filler layer; and the second filler layer and the first filler layer are each provided with the water collection pump.

The first filler layer is a waste red brick particle layer; the second filler layer is a biomass particle layer; the third filler layer is a modified shale ceramisite filler layer; and the fourth filler layer is a honeycomb porous ceramic filler layer.

Alternatively, the water drainage part at least includes a movable porous water outflow turntable; the water drainage filled column includes a fourth filler layer, a third filler layer, a second filler layer, and a first filler layer in sequence from bottom to top; and the movable porous water outflow turntable is mounted at a bottom of the fourth filler layer.

The first filler layer is a waste red brick particle layer; the second filler layer is a biomass particle layer; the third filler layer is a modified shale ceramisite filler layer; and the fourth filler layer is a honeycomb porous ceramic filler layer.

Alternatively, semi-flexible support structures and amphibious type aquatic plants planted on the semi-flexible support structures are provided inside the water collection tanks;
the water collection tanks are provided with water inflow holes and water outflow holes; the heights of the water inflow holes are less than the heights of the water outflow holes; the water inflow holes are used for introducing the water subjected to the primary filtration treatment into the water collection tanks; the water outflow holes are communicated with the water distribution pipes;
the water distribution pipes are provided on the platform wetland sub-system in a pound sign form.

Alternatively, the semi-flexible support structures include water retention and absorption cotton pad layers and quartz sand layers in sequence from bottom to top.

Alternatively, the platform wetland sub-system includes a filler frame; a base pad layer, a filler structure layer, and a surface coverage water retention layer are provided in the filler frame in sequence from bottom to top;
the water distribution pipes are provided on the surface coverage water retention layer;
the filler structure layer is composed of three or more filler layers, and each filler layer includes a first filler bag, a second filler bag, a third filler bag and a fourth filler bag which are stacked in a staggered manner;
a filler in the first filler bag is honeycomb activated zeolite; a filler in the second filler bag is granular biomass carbon and FeS₂ mineral particles; a filler in the third filler bag is lightweight ceramsite; and a filler in the fourth filler bag is a molecular sieve porous lightweight material.

Alternatively, the base pad layer is composed of special mesh fabric; the special mesh fabric includes an anti-seepage film, a coconut tree fiber layer, and a carbon fiber layer in sequence from bottom to top;

a material of the surface coverage water retention layer is PP cotton.

Alternatively, a wind-photovoltaic hybrid distributed power supply sub-system and a wetland plant sub-system are further included;

the wind-photovoltaic hybrid distributed power supply sub-system is provided at an edge of the water purification central platfrom, and the wetland plant sub-system is provided on the water distribution pipe.

Alternatively, the lake center platform for water purification includes a platform, a fence, and a support frame; the platform is of a water collection cavity structure; the support frame is mounted on the platform; the fence is fixed on the platform through the support frame; the water collection and distribution sub-system, the platform wetland sub-system, and the wetland plant sub-system are provided in the fence; and the wind-photovoltaic hybrid distributed power supply sub-system is provided outside the fence.

Alternatively, the wetland plant sub-system includes a filing material, a plant cultivation hole mold, and a hygrophyte in sequence from bottom to top;

the filing material is provided on the water distribution pipes; the filing material is of a two-layer structure; the lower layer of filing material is water absorption cotton; and the upper layer of filing material is a support for cultivating the hygrophyte.

According to the specific embodiments provided by the present disclosure, the present disclosure discloses the following technical effects.

The present disclosure provides a floating-island type artificial wetland treatment system based on a lake center platform. During operation, the lake center platform for water purification is located in a water domain to be purified; sewage to be purified in the water domain to be purified is introduced into the water inflow filled columns through the water collection parts, and is subjected to primary filtration treatment by the water inflow filled columns; water obtained after the primary filtration treatment is introduced into the water collection tanks and is then introduced, through the water distribution pipes between the respective water collection tanks, to the platform wetland sub-system for secondary filtration treatment by the platform wetland sub-system; water obtained after the secondary filtration treatment flows into the water drainage filled column for third filtration treatment by the water drainage filled column; and the water obtained after the third filtration treatment is drained through the water drainage part. The purpose of in-situ water deeutrophication on the basis of not occupying lands beside the water domain to be purified is achieved.

### BRIEF DESCRIPTION OF THE DRAWINGS

In order to describe the embodiments of the present disclosure or technical solutions in the existing art more clearly, drawings required to be used in the embodiments will be briefly introduced below. Apparently, the drawings in the descriptions below are only some embodiments of the present disclosure. Those ordinarily skilled in the art also can acquire other drawings according to these drawings without creative work.

FIG. 1 is a schematic structural diagram of a floating-island type artificial wetland treatment system based on a lake center platform;

FIG. 2 is a schematic diagram of a practical design of a floating-island type artificial wetland treatment system based on a lake center platform;

FIG. 3 is a schematic diagram of a practical design of a water inflow filled column of the present disclosure; and

FIG. 4 is a schematic diagram of a practical design of a water inflow filled column of the present disclosure.

### DETAILED DESCRIPTION OF THE EMBODIMENTS

The following clearly and completely describes the technical solutions in the embodiments of the present disclosure in combination with the accompanying drawings of the embodiments of the present disclosure. Apparently, the described embodiments are only part of the embodiments of the present disclosure, not all embodiments. Based on the embodiments in the present disclosure, all other embodiments obtained by those of ordinary skill in the art without creative work shall fall within the protection scope of the present disclosure.

The present disclosure aims to provide a floating-island type artificial wetland treatment system based on a lake center platform, so as to achieve the purpose of in-situ water deeutrophication on the basis of not occupying lands beside a water domain to be purified.

In order to make the above-mentioned purposes, characteristics and advantages of the present disclosure more obvious and understandable, the present disclosure is further described in detail below with reference to the accompanying drawings and specific implementation modes.

Although an artificial wetland technology is a sewage treatment technology and water purification technology with wide application prospects, there are certain problems in its promotion and use, mainly including: first, a limited hydraulic load of a wetland leads to a large occupation area of the wetland; the artificial wetlands occupy an area that is at least twice the area of the conventional sewage treatment process, so that the artificial wetlands are difficultly promoted in places with land shortage or places with higher land price; second, as the running time of the wetland is prolonged, some nutrients will gradually be accumulated; if the maintenance is improper, siltation, blockage, and obstruction are easily caused, which will reduce the hydraulic conductivity, the wetland treatment efficiency, and the service life; third, with the continuous operation of the sewage treatment process, the adsorption capacity of a matrix will tend to be saturated after several years, which will also affect the treatment effect of the wetlands; fourth, the survival of aquatic plants and microorganisms requires a certain amount of water, so it is difficult for the artificial wetlands to resist the arid climate; fifth, some subsurface wetlands with unreasonable construction design or maintenance and management will cause waterlogging on surfaces; sixth, a surface flow wetlands have a large water surface, which will breed a large number of mosquitoes and flies to threaten the health of people around the wetlands; seventh, since artificial wetlands have certain anoxic and anaerobic regions, some anaerobic reactants (such as H₂S and odoriferous substances) will diffuse into the air and cause the diffusion of odor; eighth, a lower temperature can weaken various biological activities of a wetland system, and plants in growth retardation at a low temperature or dead plants have reduced oxygen release property or even do not release oxygen to the wetland, thereby reducing or losing their abilities of purifying wastewater; ninth, there are problems of plant diseases and insect pests of plants of the wetland, fire, self-growth cycle, related maintenance, repair, management, and the like; and tenth, the artificial wetlands are innovatively applied in other fields.

As the proposal and development of the artificial wetland technology is still short, the technological development still cannot meet the current social needs. The application of artificial wetlands mainly relies on experience, and there is a tendency to over-indulge natural conditions and ignore artificial strengthening, which affects the achievable different load treatment effects. For example, the artificial wetlands are suitable for an optimal combination and vertical crossing of aquatic plant species under different regional conditions; pretreatment, post-treatment, distribution, water collection, and the like of processes are processized; there are few researches on the scientific configuration for bed base materials, the structures of wetlands, the characteristics of alternate flow patterns of subsurface and surface layers, and the design theories and methods, so the systematicness and integrity are low. In addition to heavy nitrogen and phosphorus pollution in eutrophic water, the low oxygen problem and the water bloom risk of water are also prominent. Flow aeration of water can alleviate the problem of low oxygen in water. Water blooms, algae, and other biological suspended matters, medium-sized aquatic animals in water need to be intercepted in an in-situ treatment process. At present, such a complex, ecological and landscape purification system has not been seen in the treatment of eutrophication of water.

In order to promote the treatment of eutrophication of water, and more efficiently and practically treat the eutrophication problem or water bloom risk problem in a static water region of an aquatic ecosystem (lakes, rivers, reservoirs, etc.), the present disclosure provides a floating-island type artificial wetland treatment system adopting a lake center platform, which is a new in-situ long time series treatment technology for eutrophic water in a rivers and a lakes, a platform, and a use of the floating-island type artificial wetland treatment system.

### Embodiment I

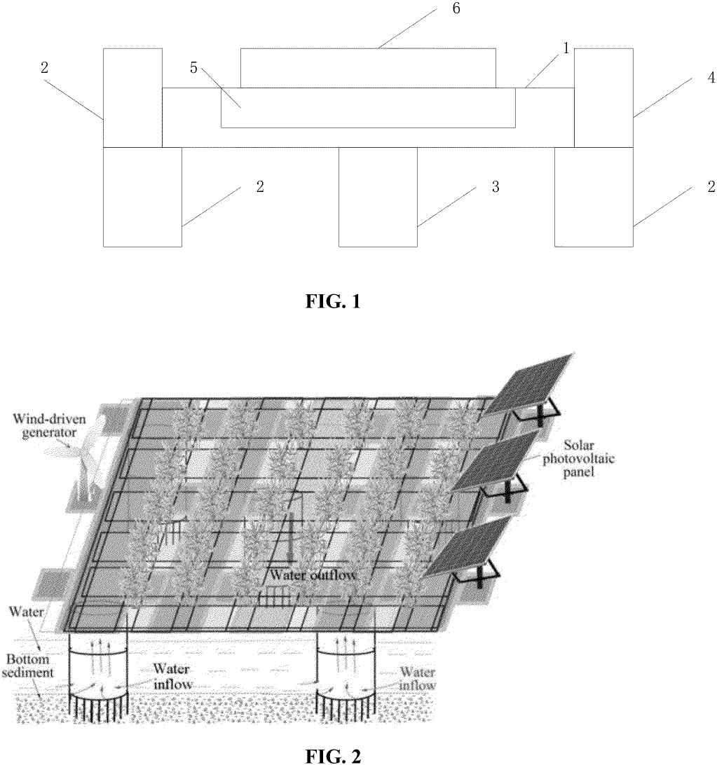

As shown in FIG. 1, a floating-island type artificial wetland treatment system based on a lake center platform provided by this embodiment, including a lake center platform for water purification 1, a water inflow sub-system 2, a water drainage sub-system 3, a water collection and distribution sub-system 4, and a platform wetland sub-system 5; the water inflow sub-system 2 includes a plurality of water inflow filled columns and a water collection part provided on each water inflow filled column; the water drainage sub-system 3 includes one or more water drainage filled columns and a water drainage part provided on each water drainage filled column; the water inflow filled columns and the water drainage filled column are filled with multiple kinds of fillers; the water collection and distribution sub-system 4 includes a plurality of water collection tanks and water distribution pipes arranged between the respective water collection tanks; the platform wetland sub-system 5 is filled with multiple kinds of fillers;

the water inflow filled columns and the water drainage filled column are mounted at a bottom of the lake center platform for water purification 1; the water collection and distribution sub-system 4 and the platform wetland sub-system 5 are mounted on the lake center platform for water purification 1; wherein, the water drainage filled column is located in a center of the lake center platform for water purification 1; the plurality of water inflow filled columns are uniformly distributed at an edge of the lake center platform for water purification 1 with the water drainage filled column as a center; the platform wetland sub-system 5 is located in a center region of the lake center platform for water purification 1; the plurality of water collection tanks are uniformly distributed at the edge of the lake center platform for water purification 1 with the platform wetland sub-system 5 as a center; and the water distribution pipes are provided on the platform wetland sub-system 5.

During operation, the lake center platform for water purification 1 is located in a water domain to be purified; sewage to be purified in the water domain to be purified is introduced into the water inflow filled columns through the water collection parts, and is subjected to primary filtration treatment by the water inflow filled columns; water obtained after the primary filtration treatment is introduced into the water collection tanks and is then introduced, through the water distribution pipes between the respective water collection tanks, to the platform wetland sub-system 5 for secondary filtration treatment by the platform wetland sub-system 5; water obtained after the secondary filtration treatment flows into the water drainage filled column for third filtration treatment by the water drainage filled column; and the water obtained after the third filtration treatment is drained through the water drainage part.

In this embodiment, the water inflow sub-system 2 further includes a fixing frame used for fixing plastic-steel structures of the water inflow filled columns; each of the water collection parts includes a porous water inflow storehouse and a water collection pump; the water inflow filled columns include a fourth filler layer, a third filler layer, a second filler layer, and a first filler layer in sequence from bottom to top; the porous water inflow storehouse is mounted at a bottom of the fourth filler layer; and the second filler layer and the first filler layer are provided with the water collection pump.

Preferably, the first filler layer is a waste red brick particle layer; the second filler layer is a biomass particle layer; the third filler layer is a modified shale ceramisite filler layer; and the fourth filler layer is a honeycomb porous ceramic filler layer.

Preferably, the number of the water inflow filled columns is 4, and each water inflow filled column has a size of Φ 600-1200 mm and a height of 2-4 m.

Preferably, the water collection pump includes a water collection hole and a vacuum pump provided in the water collection hole.

In this embodiment, the water drainage sub-system 3 further includes a fixing frame used for fixing a plastic-steel structure of the water drainage filled column; and the water drainage part at least includes a movable porous water outflow turntable. The water drainage filled column includes a fourth filler layer, a third filler layer, a second filler layer, and a first filler layer in sequence from bottom to top; and the movable porous water outflow turntable is mounted at a bottom of the fourth filler layer.

Preferably, the first filler layer is a waste red brick particle layer; the second filler layer is a biomass particle layer; the third filler layer is a modified shale ceramisite filler layer; and the fourth filler layer is a honeycomb porous ceramic filler layer.

Preferably, the number of the water drainage filled columns is 1, and the water drainage filled column has a size of Φ 600-1200 mm and a height of 2-4 m.

In this embodiment, semi-flexible support structures and amphibious type aquatic plants (such as limnophila heterophylla, hydrocharis dubia, myriophyllum spicatum, and villarisa nymphaeoides) planted on the semi-flexible support structures are provided inside the water collection tanks in the water collection and distribution sub-system 4.

The water collection tanks are provided with water inflow holes and water outflow holes; the heights of the water inflow holes are less than the heights of the water outflow holes; the water inflow holes are used for introducing the water subjected to the primary filtration treatment into the water collection tanks; the water outflow holes are communicated with the water distribution pipes; and the water distribution pipes are provided on the platform wetland sub-system in a pound sign form.

The semi-flexible support structures include water retention and absorption cotton pad layers and quartz sand layers in sequence from bottom to top. The height of the water retention and absorption cotton pad layer is 1-3 cm, and the height of the quartz sand layer is 3-5 cm.

Preferably, a material of the water collection tank is glass fiber reinforced plastic; the water collection tank has a width of 40 cm and a height of 50 cm; and the water outflow hole of the water collection tank is provided at a position that is 5-10 cm away from the bottom.

Preferably, the water distribution pipes are non-uniform porous drip irrigation pipes.

Preferably, the number of the water collection tanks is greater than or equal to the number of the water inflow filled columns, such as 16 water collection tanks. Four water collection tanks are provided on each side of the lake center platform for water purification.

In this embodiment, the platform wetland sub-system 5 includes a filler frame having a height of 0.7-1 m and is made of glass or plastic steel; a base pad layer, a filler structure layer, and a surface coverage water retention layer are provided in the filler frame in sequence from bottom to top.

The filler structure layer is composed of three or more filler layers, and each filler layer is composed of a first filler bag, a second filler bag, a third filler bag and a fourth filler bag which are stacked in a staggered manner. The filler bags of each filler layer are randomly composed of the above four kinds of filler bags, and the filler bags on all the filler layers are the same, but the filler bags are not connected with each other.

Preferably, a filler in the first filler bag is honeycomb activated zeolite; a filler in the second filler bag is granular biomass carbon and FeS₂ mineral particles; a filler in the third filler bag is lightweight ceramsite; and a filler in the fourth filler bag is a molecular sieve porous lightweight material.

Preferably, in this embodiment, the base pad layer is composed of special mesh fabric; and the special mesh fabric includes an anti-seepage film, a coconut tree fiber layer, and a carbon fiber layer in sequence from bottom to top.

Preferably, in this embodiment, a material of the surface coverage water retention layer is PP cotton.

Further, after the filler bags are provided inside the filler frame, before the trial operation of the system, one layer of efficient denitrifying bacteria agent is sprinkled on the surface coverage water retention layer.

In this embodiment, the floating-island type artificial wetland treatment system based on the lake center platform further includes a wind-photovoltaic hybrid distributed power supply sub-system and a wetland plant sub-system 6.

In this embodiment, the wind-photovoltaic hybrid distributed power supply sub-system includes a solar photovoltaic panel, a photovoltaic power generation controller, a small-sized wind driven generator, a wind power generation controller, a storage battery pack, and a connection wire. The wind power generation controller, the storage battery pack and the photovoltaic power generation controller which are disposed at the same level as the wind power generation controller, the connection wire, the solar photovoltaic panel, and the small-sized wind driven generator are provided in the wind-photovoltaic hybrid distributed power supply sub-system in sequence from bottom to top.

In this embodiment, the wetland plant sub-system is provided on the water distribution pipes. The wetland plant sub-system includes a filing material, a plant cultivation hole mold, and a hygrophyte (such as cattail, canna indica, and arundodonaxvar) in sequence from bottom to top.

Preferably, in this embodiment, the filing material is of a two-layer structure. The lower layer of filing material is water absorption cotton; and the upper layer of filing material is a support for cultivating the hygrophyte.

In this embodiment, the wetland plant sub-system is further provided with fungal inoculant (such as penicillium oxalicum and glomus fasciculatum). According to the chronological order, the fungal inoculant is added to a root system of a wetland plant at a dosage of 50-150 g per hole after the wetland plant is disposed.

In this embodiment, the lake center platform for water purification 1 includes a platform, a fence, and a plurality of support frames; the platform is of a water collection cavity structure composed of a two-layer toughened glass material or plastic-steel material; the support frames are mounted on the platform; the fence is fixed on the platform through the support frames; the water collection and distribution sub-system, the platform wetland sub-system, and the wetland plant sub-system are provided in the fence; and the wind-photovoltaic hybrid distributed power supply sub-system is provided outside the fence.

For horizontal spatial arrangement, the water inflow sub-system is located at the outermost periphery of the bottom of the lake center platform for water purification; the water drainage sub-system (which is a sub-system at the same level of the water inflow sub-system) is located in the center of the bottom of the lake center platform for water purification; the wind-photovoltaic hybrid distributed power supply sub-system is provided at the outermost periphery of the lake center platform for water purification; and four water collection tanks, water distribution pipes, platform wetland sub-systems, and wetland plant sub-systems are respectively provided inwardly in sequence along the side of the lake center platform for water purification.

For vertical spatial arrangement, the water inflow sub-system (or the water drainage sub-system), the lake center platform for water purification, and the water collection and distribution system (or the platform wetland sub-system or the wetland plant sub-system or the wind-photovoltaic hybrid distributed power supply sub-system) are provided in sequence from bottom to top.

For a system connection relation, the water collection tanks in the water collection and distribution sub-system are connected behind the water inflow sub-system, and the water distribution pipes are then synchronously disposed; the water collection tanks in the water collection and distribution sub-system are provided with interception systems for the amphibious type aquatic plants; the platform wetland sub-system, the wetland plant sub-system, and the water drainage sub-system are connected behind the water collection and distribution sub-system in sequence; the wind-photovoltaic hybrid distributed power supply sub-system and the lake center platform for water purification are a power supply, control facility and a support architecture and are a basic support for the operation of the treatment system.

One specific application example of this system is described below.

According to results of previous studies and compound pollution characteristics of a targeted water domain, a systematic floating-island type artificial wetland treatment system based on a lake center platform as shown in FIG. 2, FIG. 3, and FIG. 4 is designed, which aims at implementing fixed-point water treatment for small-size eutrophic lake or cofferdam water polluted by heavy metals and carrying out pumping, backwashing, and other procedures by virtue of natural energy and a backup power supply. The system includes two major sections: One includes five or more filled columns, with a size of Φ 600-1200 mm and a height of 2-4 m. The filled columns are anchored by plastic-steel structured fixing systems. Four filled columns located at the edges are used for feeding water, and one filled column located in the center is used for draining water. The Fillers inside each filled column are divided into four layers, including a honeycomb porous ceramic filler layer (filler 4), a modified shale ceramisite filler layer (filler 3), a biomass particle layer (filler 2), and a waste red brick particle layer (filler 1) in sequence from bottom to top; the uppermost two filler layers of each water inflow filled column are provided with 3-5 water collection holes, and pumps (the setting depth of which is lower than a water level of lake water) are provided in the water collection holes. The other one is a water collection and distribution and two-stage water purification platform. The two-stage water purification platform consists of a lightweight aluminum alloy support framework and a plastic-steel water collection cavity, and a base pad layer consists of one layer of carbon fiber plus coconut tree fiber plus anti-seepage film special mesh fabric; a filler system consists of three or more layers of filler bags that are stacked in a staggered manner (filler bag 1: honeycomb activated zeolite; filler bag 2: granular biomass carbon and FeS₂ mineral particles; filler bag 3: lightweight ceramsite; filler bag 4: a molecular sieve porous lightweight material) and includes water distribution pipes; plant cultivation holes are set in spatial gaps caused by staggered stacking, and cattail and other plants are provided in the plant cultivation holes for constructing vegetations. The wind-photovoltaic hybrid distributed power supply sub-system provides electric energy in a complementary manner for intermittent or continuous pumping treatment.

All the embodiments in the specification are described in a progressive manner. Contents mainly described in each embodiment are different from those described in other embodiments. Same or similar parts of all the embodiments refer to each other.

The principle and implementation modes of the present disclosure are described by applying specific examples herein. The descriptions of the above embodiments are only intended to help to understand the method of the present disclosure and a core idea of the method. In addition, those ordinarily skilled in the art can make changes to the specific implementation modes and the application scope according to the idea of the present disclosure. From the above, the contents of the specification shall not be deemed as limitations to the present disclosure.

What is claimed is:

1. A floating-island type artificial wetland treatment system based on a lake center platform, comprising:
a lake center platform for water purification;
a water inflow sub-system, comprising a plurality of water inflow filled columns and a water collection part provided on each water inflow filled column;
a water drainage sub-system, comprising one or more water drainage filled column and a water drainage part provided on each water drainage filled column;
a water collection and distribution sub-system, comprising a plurality of water collection tanks and water distribution pipes arranged between the respective water collection tanks; and
a platform wetland sub-system, being filled with multiple kinds of fillers;
the water inflow filled columns and the water drainage filled column are filled with multiple kinds of fillers and are mounted at a bottom of the lake center platform for water purification; the water collection and distribution sub-system and the platform wetland sub-system are mounted on the lake center platform for water purification; wherein, the water drainage filled column is located in a center of the lake center platform for water purification; the plurality of water inflow filled columns are uniformly distributed at an edge of the lake center platform for water purification with the water drainage filled column as a center; the platform wetland sub-system is located in a center region of the lake center platform for water purification; the plurality of water collection tanks are uniformly distributed at the edge of the lake center platform for water purification with the platform wetland sub-system as a center; the water distribution pipes are provided on the platform wetland sub-system;
during operation, the lake center platform for water purification is located in a water domain to be purified; sewage to be purified in the water domain to be purified is introduced into the water inflow filled columns through the water collection parts, and is subjected to a primary filtration treatment by the water inflow filled columns; water obtained after the primary filtration treatment is introduced into the water collection tanks and is then introduced, through the water distribution pipes between the respective water collection tanks, to the platform wetland sub-system for a secondary filtration treatment by the platform wetland sub-system; water obtained after the secondary filtration treatment flows into the water drainage filled column for a third filtration treatment by the water drainage filled column; and water obtained after the third filtration treatment is drained through the water drainage part.

2. The floating-island type artificial wetland treatment system based on the lake center platform according to claim 1, wherein, each of the water collection parts comprises a porous water inflow storehouse and a water collection pump; the water inflow filled columns each comprises a fourth filler layer, a third filler layer, a second filler layer, and a first filler layer in sequence from bottom to top; the porous water inflow storehouse is mounted at a bottom of the fourth filler layer; the second filler layer and the first filler layer are both provided with the water collection pump;
the first filler layer is a waste red brick particle layer; the second filler layer is a biomass particle layer; the third filler layer is a modified shale ceramisite filler layer; and the fourth filler layer is a honeycomb porous ceramic filler layer.

3. The floating-island type artificial wetland treatment system based on the lake center platform according to claim 1, wherein, the water drainage part at least comprises a movable porous water outflow turntable; the water drainage filled column comprises a fourth filler layer, a third filler layer, a second filler layer, and a first filler layer in sequence from bottom to top; the movable porous water outflow turntable is mounted at a bottom of the fourth filler layer;
the first filler layer is a waste red brick particle layer; the second filler layer is a biomass particle layer; the third filler layer is a modified shale ceramisite filler layer; and the fourth filler layer is a honeycomb porous ceramic filler layer.

4. The floating-island type artificial wetland treatment system based on the lake center platform according to claim 1, wherein, semi-flexible support structures and amphibious type aquatic plants planted on the semi-flexible support structures are provided inside the water collection tanks;
the water collection tanks are provided with water inflow holes and water outflow holes; the heights of the water inflow holes are less than the heights of the water outflow holes; the water inflow holes are used for introducing the water subjected to the primary filtration treatment into the water collection tanks; the water outflow holes are in communication with the water distribution pipes;
the water distribution pipes are provided on the platform wetland sub-system in a pound sign form.

5. The floating-island type artificial wetland treatment system based on the lake center platform according to claim 4, wherein, the semi-flexible support structures each comprises a water retention and absorption cotton pad layer and quartz sand layer in sequence from bottom to top.

6. The floating-island type artificial wetland treatment system based on the lake center platform according to claim 1, wherein, the platform wetland sub-system comprises a filler frame; a base pad layer, a filler structure layer, and a surface coverage water retention layer are provided in the filler frame in sequence from bottom to top;
the water distribution pipes are provided on the surface coverage water retention layer;
the filler structure layer is composed of three or more filler layers, and each filler layer comprises a first filler bag, a second filler bag, a third filler bag and a fourth filler bag which are stacked in a staggered manner;
wherein, a filler in the first filler bag is honeycomb activated zeolite; a filler in the second filler bag is granular biomass carbon and FeS₂ mineral particles; a filler in the third filler bag is lightweight ceramsite; and a filler in the fourth filler bag is a molecular sieve porous lightweight material.

7. The floating-island type artificial wetland treatment system based on the lake center platform according to claim 6, wherein, the base pad layer is composed of special mesh fabric; the special mesh fabric comprises an anti-seepage film, a coconut tree fiber layer, and a carbon fiber layer in sequence from bottom to top;
a material of the surface coverage water retention layer is PP cotton.

8. The floating-island type artificial wetland treatment system based on the lake center platform according to claim 1, further comprising a wind-photovoltaic hybrid distributed power supply sub-system and a wetland plant sub-system,
wherein, the wind-photovoltaic hybrid distributed power supply sub-system is provided at an edge of the water purification central platform, and the wetland plant sub-system is provided on the water distribution pipes.

9. The floating-island type artificial wetland treatment system based on the lake center platform according to claim 8, wherein the lake center platform for water purification comprises:
a platform, being of a water collection cavity structure;
a support frame, being mounted on the platform; and
a fence, being fixed on the platform through the support frame;
the water collection and distribution sub-system, the platform wetland sub-system, and the wetland plant sub-system are provided inside the fence; and the wind-photovoltaic hybrid distributed power supply sub-system is provided outside the fence.

10. The floating-island type artificial wetland treatment system based on the lake center platform according to claim 8, wherein, the wetland plant sub-system comprises a filling material, a plant cultivation hole mold, and a hygrophyte in sequence from bottom to top;
the filing material is provided on the water distribution pipes; the filing material is of a two-layer structure; a lower layer of the filing material is water absorption cotton; and an upper layer of the filing material is a support for cultivating the hygrophyte.
